(19) United States
(12) Patent Application Publication
(10) Pub. No.: US 2014/0190616 A1
(43) Pub. Date: Jul. 10, 2014

(54) DOUBLE-SIDED ADHESIVE MEMBRANE FOR FINISH MATERIAL INSTALLATION

(71) Applicant: ST Global Partners, LLC, San Diego, CA (US)

(72) Inventor: Carl Thomas Archbold, San Diego, CA (US)

(21) Appl. No.: 14/144,286

(22) Filed: Dec. 30, 2013

Related U.S. Application Data
(60) Provisional application No. 61/750,460, filed on Jan. 9, 2013.

(51) Int. Cl. C09J 7/02; B32B 38/10

(52) U.S. Cl. CPC C09J 7/02; B32B 38/10
USPC 156/71; 428/317.3; 428/159; 428/41.3

(57) ABSTRACT

A finish material installation membrane is described. The membrane includes: a first adhesive layer; a structural layer coupled to the first adhesive layer; a second adhesive layer coupled to the structural layer, and a backing layer coupled to the second adhesive layer. A double-sided adhesive membrane adapted to secure finish material to a sub-surface includes: a structural layer; a first adhesive layer coupled to a first surface of the structural layer; a second adhesive layer coupled to a second surface of the structural layer; a first release liner coupled to the first adhesive layer; and a second release liner coupled to the second adhesive layer.

### CROSS-REFERENCE TO RELATED APPLICATIONS

This application claims priority to U.S. Provisional Patent Application Ser. No. 61/750,460, filed on Jan. 9, 2013.

### BACKGROUND OF THE INVENTION

Many construction projects require the application of various finish materials (e.g., wood flooring, tile, etc.) to a sub-surface (e.g., a subfloor, wall, etc.). Typically, such application may require an installer to prepare and/or apply various securing elements (e.g., adhesive, nails, screws, etc.). Such preparation and/or application may require time-consuming activities such as mixing of adhesive elements, acquiring and/or manipulating tools and fasteners, etc.

Therefore, there exists a need for a way to securely attach finish materials to a base layer without requiring an installer to prepare or apply any adhesive compounds or other fastening elements.

### BRIEF SUMMARY OF THE INVENTION

A first exemplary embodiment of the invention provides a finish material installation membrane. The membrane includes: a first adhesive layer; a structural layer coupled to the first adhesive layer; a second adhesive layer coupled to the structural layer, and a backing layer coupled to the second adhesive layer.

A second exemplary embodiment of the invention provides a double-sided adhesive membrane adapted to secure finish material to a sub-surface. The double sided adhesive membrane includes: a structural layer; a first adhesive layer coupled to a first surface of the structural layer; a second adhesive layer coupled to a second surface of the structural layer; a first release liner coupled to the first adhesive layer; and a second release liner coupled to the second adhesive layer.

A third exemplary embodiment of the invention provides a method of installing finish material to a sub-surface using a double-sided adhesive membrane. The method includes: removing a first release liner from the adhesive membrane to expose a first adhesive layer; securing the adhesive membrane to the sub-surface via the first adhesive layer; removing a second release liner from the adhesive membrane to expose a second adhesive layer; and securing finish material to the second adhesive layer.

The preceding Summary is intended to serve as a brief introduction to various features of some exemplary embodiments of the invention. Other embodiments may be implemented in other specific forms without departing from the spirit of the invention.

### BRIEF DESCRIPTION OF THE SEVERAL VIEWS OF THE DRAWINGS

The novel features of the invention are set forth in the appended claims. However, for purpose of explanation, several embodiments of the invention are set forth in the following drawings.

FIG. 1 illustrates a side view of a section of adhesive membrane according to an exemplary embodiment the invention;

FIG. 2 illustrates a section view of the membrane of FIG. 1 in use;

FIG. 3 illustrates a top view of multiple rectangular sheets of the membrane of FIG. 1 in use;

FIG. 4 illustrates side views of an alternative configuration of the membrane of FIG. 1, where a length of membrane is rolled onto a cylindrical core;

FIG. 5 illustrates a top view of the membrane of FIG. 1 in use in the alternative configuration of FIG. 4;

FIG. 6 illustrates a flow chart of a conceptual process used by some embodiments to perform an installation using multiple rectangular sheets of the membrane of FIG. 1; and

FIG. 7 illustrates a flow chart of a conceptual process used by some embodiments to perform an installation using the alternative membrane configuration of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, as the scope of the invention is best defined by the appended claims.

Various inventive features are described below that can each be used independently of one another or in combination with other features. Broadly, some embodiments of the present invention generally provide a way to secure various finish materials (e.g., flooring, wall covering, ceiling covering, etc.) to a sub-surface (e.g., a subfloor, a sub-ceiling, etc.). Such a sub-surface may include various appropriate materials (e.g., plywood, concrete, etc.). Some embodiments provide a membrane that may be placed between the sub-surface and the finish materials. The membrane may include a first adhesive surface that is adapted to be coupled to the sub-surface. The membrane may include a second adhesive surface that is adapted to be coupled to a surface of the finish materials. The membrane may include various appropriate materials that may provide various appropriate properties (e.g., moisture blocking, noise reduction, etc.).

In some embodiments, the membrane may provide sound dampening, impact insulation, waterproofing, and/or other features, as appropriate. During installation, the membrane may be held in place after being adhered to the sub-surface such that the membrane will not shift or otherwise move while finish materials are installed. Such a membrane may allow installation of various finish materials without need of any adhesives (other than those provided by the membrane itself) or other fastening elements (e.g., nails, screws, etc.).

Although several examples below may refer to specific sub-surfaces (e.g., a subfloor) and/or finish materials (e.g., wood flooring), one of ordinary skill in the art will recognize that such specific references are provided for illustrative purposes only and different embodiments may be implemented for use with various different specific sub-surfaces (e.g., a wall or ceiling surface) and/or finish materials (e.g., the flooring, sheetrock, etc.).

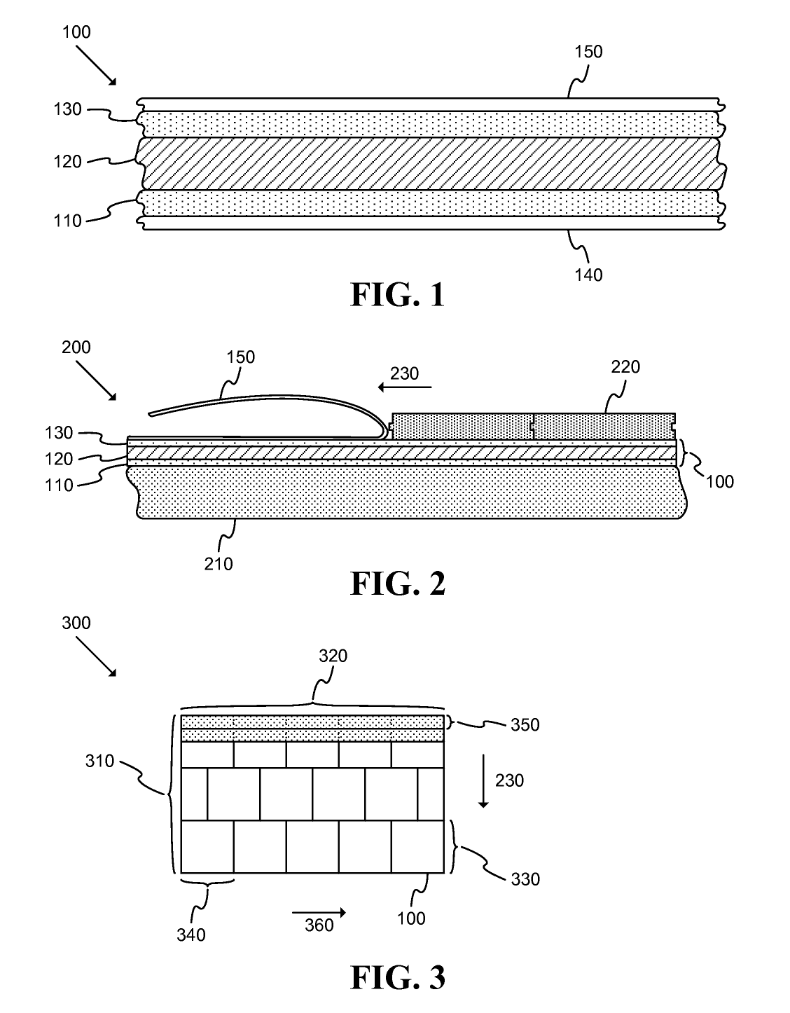

FIG. 1 illustrates a side view of a section of adhesive membrane 100 according to an exemplary embodiment the invention. Specifically, this figure shows the various layers included in the membrane in some embodiments. As shown, the membrane may include a first adhesive layer 110, a structural layer 120, a second adhesive layer 130, a first backing layer 140 (or release liner), and a second backing layer 150.

The first adhesive layer 110 may include various appropriate materials that may be able to adhere to a sub-surface. Different embodiments may include different types of adhesives, different thicknesses of the adhesive layer, and/or otherwise appropriately vary the properties of the adhesive layer. The adhesive layer may be coupled to the structural layer 120 and the first backing layer 140.

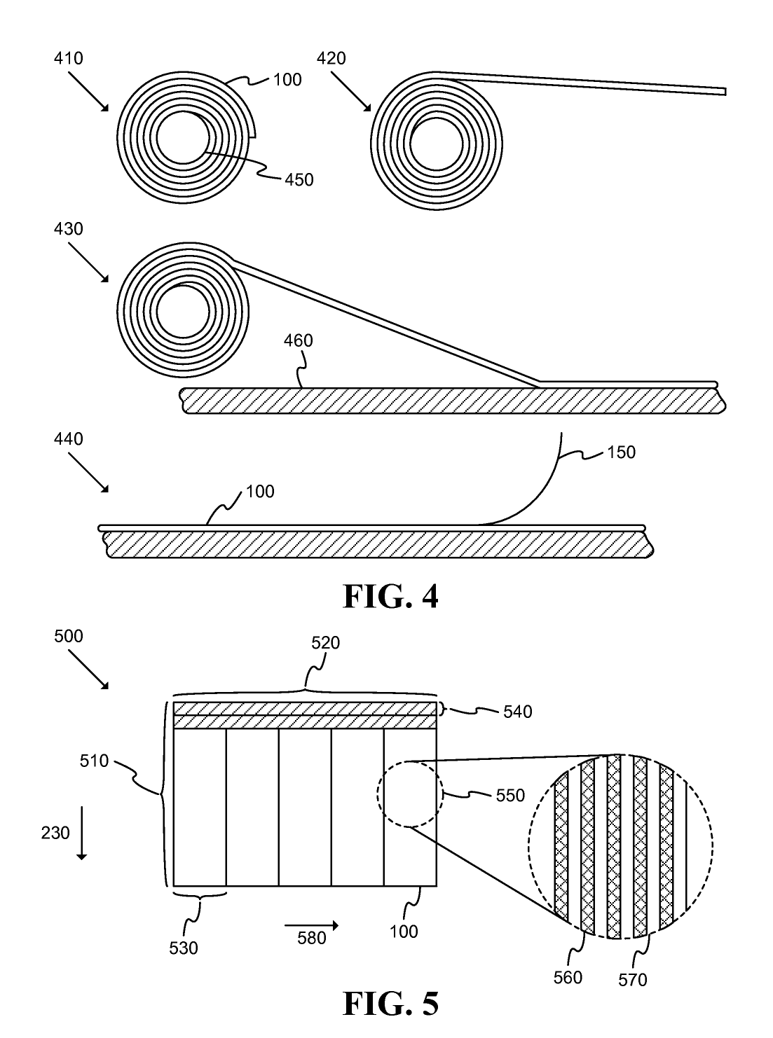

In some embodiments, the first adhesive layer 110 may not include a release liner such that the membrane may be rolled onto a core. Such an arrangement will be described in more detail in reference to FIG. 4 below.

Returning to FIG. 1, the structural layer 120 may be made of closed-cell foam rubber. In some embodiments, the structural layer may include various appropriate materials (e.g., neoprene, styrene-butadiene rubber (SBR), etc.) that may be blended in various appropriate ratios. The structural layer may be made in various thicknesses for various applications (e.g., three thirty-seconds of an inch for wood flooring installation). The structural layer may be coupled to the first adhesive layer 110 and the second adhesive layer 130.

The structural layer 120, either alone or in combination with other layers, may be adapted to provide various properties and characteristics. For instance, the structural layer may provide waterproofing such that no separate moisture blocking membrane is needed. As another example, the structural layer may provide vibration damping capability such that noise is reduced when passing through the membrane. As yet another example, the structural layer may provide impact insulation in some embodiments.

The second adhesive layer 130 may include various appropriate materials that may be able to adhere to various finish materials. Different embodiments may include different types of adhesives, different thicknesses of the adhesive layer, and/or otherwise appropriately vary the properties of the adhesive layer. The second adhesive layer 130 may be coupled to the structural layer 120 and the second backing layer 150. In some embodiments, the second adhesive layer 130 may not cover the entire surface of the structural layer 120. In some of these embodiments, the second adhesive layer 130 may include various arrangements of adhesive sections and empty spaces among the arranged adhesive sections. Such spacing among adhesive sections of the second adhesive layer may allow for repositioning of flooring materials during installation as well as being easier to manufacture and using fewer materials.

The backing layers 140-150 may each include various appropriate materials (e.g., paper) that may allow the backing layers to be removed from each of the the adhesive layers 110 and 130 to expose the adhesive surface provided by each adhesive layer.

One of ordinary skill in the art will recognize that the representation of the adhesive membrane 100 shown in FIG. 1 is conceptual in nature and various embodiments of the membrane may be implemented in various different ways without departing from the spirit of the invention. For instance, the thicknesses of the various layers are not meant to represent actual thicknesses or relative thicknesses of the layers, but are merely intended to illustrate various elements that may be included in the membrane.

FIG. 2 illustrates a section view 200 of the membrane 100 in use. Specifically, this figure illustrates an example use scenario to install wood flooring. As shown, the membrane may be attached on one side to a subfloor 210 and wood flooring 220 may be attached to a section of the other side of the membrane.

In this example, the first adhesive layer 110 contacts the subfloor 210 and the second adhesive layer 130 contacts the wood flooring 220. The first adhesive layer 110 may be exposed by removing the first backing layer 140 and placing a sheet of the membrane (e.g., a twenty-four inch by twenty-six inch rectangular section of membrane) onto the subfloor such that the first adhesive layer 110 contacts the subfloor.

A portion of the second backing layer 150 has been pulled away from the second adhesive layer 130 in this example to expose the adhesive surface as the wood flooring 220 is installed in direction 230. Alternatively, the second backing layer 150 may be completely removed from one or more sections of the membrane 100 such that an installer may be able to place flooring or other appropriate materials onto the exposed area. As another example, the second backing layer 150 may be divided into sections in some embodiments (e.g., by including horizontal and/or vertical cut lines through the backing layer). Such sections may correspond to various types of flooring (e.g., wood flooring of a particular width, tiles of a particular size, etc.).

The second adhesive layer 130 may include an adhesive surface that is specifically adapted to allow flooring to be moved or rearranged for a limited period of time during installation. In this way, an installer may be able to adjust the placement of flooring such as boards, tiles, etc. before securing the flooring (or other appropriate material) to a final location.

One of ordinary skill in the art will recognize that the representation of the use of the adhesive membrane 100 as shown in FIG. 2 is conceptual in nature and various embodiments of the membrane may be implemented in various different ways without departing from the spirit of the invention. For instance, the thicknesses of the various layers are not meant to represent actual thicknesses or relative thicknesses of the layers, but are merely intended to illustrate various elements that may be included in the membrane.

FIG. 3 illustrates a top view 300 of multiple rectangular sheets of the membrane 100 in use. In this example, multiple rectangular sections of the membrane 100 have been attached to a subfloor having a length 310 and a width 320. In this way, the membrane may be prevented from moving in relation to the subfloor during installation. Each section of the membrane has a length 330 and width 340. Although the subfloor and membrane sections are represented as rectangles in this example, various different shapes may be provided (and/or shapes may be cut into sections of the membrane in order to accommodate features of the area to be finished).

As shown, the membrane sections may be staggered (e.g., using half-sheet sections of membrane in some locations). Alternatively, the membrane sections may be arranged in aligned rows and columns. Different embodiments may include various differently-sized and/or shaped sections of membrane that may be able to be arranged in various patterns.

During installation, a section of the second backing 150 may be removed to expose a section of adhesive surface at least equal to the width 350 of the flooring material (or other finish material). The rows of flooring material may then be installed in a particular direction 230 along the exposed surface, wherein sections of flooring may installed in a second direction 360 along each row of material. Different installations may be performed in various different appropriate ways.

FIG. 4 illustrates side views 410-440 of an alternative configuration of the membrane 100, where a length of the membrane is rolled onto a cylindrical core 450. A first adhesive layer of the membrane 100 (e.g., layer 110) may be rolled onto the core 450, and subsequently, onto a surface of the second backing layer 150 (although in this configuration, the “second” backing layer may be the only backing layer) opposite to a surface of the backing layer that contacts the second adhesive layer 130. The first adhesive layer may be coated with an appropriate composition of materials (e.g., wax) such that the adhesive surface of the layer may not be degraded during storage and may be unrolled during use to expose the adhesive surface. In this way, the adhesive surface may retain sufficient adhesiveness to be coupled to the sub-surface.

Rolls of the membrane may include various appropriate widths (e.g., forty inches) and/or lengths (e.g., twenty feet) of the membrane as may be used in various construction applications. Such sizing may vary depending on various appropriate factors (e.g., size of the area to be covered, type of use of the area, climate, etc.).

As shown, the membrane 100 may be rolled around the core 450 as shown in side view 410. In side view 420, a section of the membrane 100 has been unrolled to expose the first adhesive surface of the membrane 100 provided by layer 110. In side view 430, a portion of the unrolled section of the membrane has been attached to a subfloor 460. In side view 440, the membrane 100 has been detached from the roll (e.g., by cutting the membrane) and attached to the subfloor 460. In addition, a portion of the second backing layer 150 has been lifted from the top surface of the membrane to expose a second adhesive surface of the membrane 100 provided by the second adhesive layer 130.

FIG. 5 illustrates a top view 500 of the membrane 100 in use in the alternative configuration of FIG. 4. As shown, in this example, multiple sections of the membrane 100 have been attached to a subfloor having a length 510 and a width 520. In this way, the membrane 100 may be prevented from moving in relation to the subfloor during installation. Each section of the membrane 100 has a length 510 and width 530. In this example, the length 510 of the membrane is the same as the length of the subfloor. However, in some embodiments multiple sections of membrane may be used to span a particular length. In addition, although in this example the width 530 of the membrane is less than the width 520 of the subfloor, in some embodiments the width of the membrane may span the width of the subfloor. In addition, although the subfloor and membrane sections are represented as rectangles in this example, various different shapes may be provided (and/or shapes may be cut into sections of the membrane).

FIG. 5 also illustrates a detailed view 550 of a section of the top view 500 of the membrane 100. The detailed view 550 shows one example layout of adhesive sections 560 and non-adhesive sections 570 (i.e., spaces between adhesive sections). Various different layouts may be used in various different embodiments. In this example, multiple strips of adhesive sections 560 are laid out lengthwise along the membrane 100. The strips and spaces alternate in a 50/50 ratio in this example. Such a ratio may be used for strips and spaces of varying size, as appropriate (e.g., one inch wide strips and spaces, two inch wide strips and spaces, etc.). In addition, the strips and/or spaces may be arranged in various patterns, as appropriate. Such patterns may be based on various appropriate factors (e.g., type, materials, and/or size of each flooring element being installed, type of expected use, etc.). Alternatively, some embodiments may include a layer of adhesive that covers the entire surface of the membrane 100.

During installation, a section of the backing layer of the membrane may be removed to expose a section of adhesive surface at least equal to the width 540 of the flooring material. The rows of flooring material may then be installed in a particular direction 580 along the exposed surface. Different installations may be performed in various different appropriate ways.

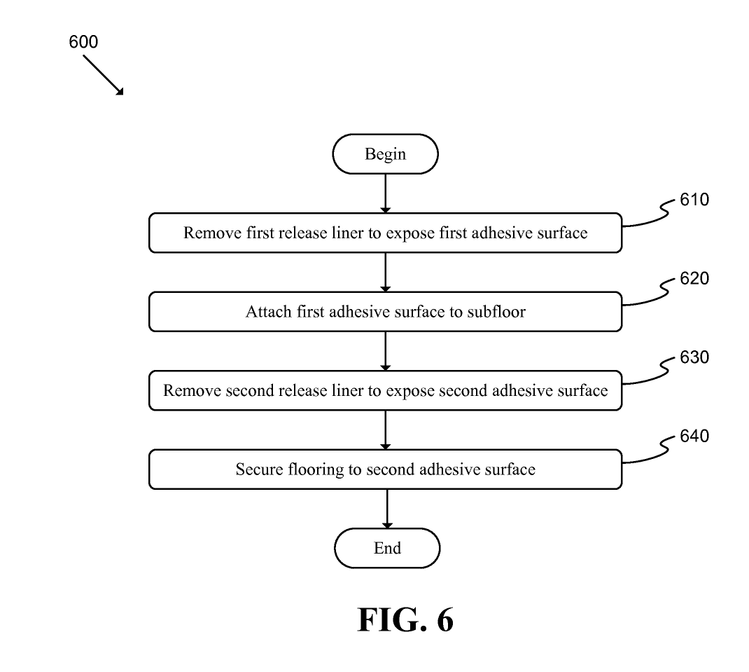

FIG. 6 illustrates a flow chart of a conceptual process 600 used by some embodiments to perform an installation using multiple rectangular sheets of the membrane of FIG. 1. Such a process may begin, for instance, when a sheet of membrane is made available. The process may remove (at 610) a first release liner to expose a first adhesive surface. The process may then attach (at 620) the first adhesive surface to a subfloor. Such attachment may be accomplished by pressing the membrane onto the subfloor with sufficient force to adhere the first adhesive surface to the subfloor. In addition, the membrane may be trimmed or otherwise shaped to fit the subfloor (or section of subfloor).

Process 600 may then remove (at 630) a second release liner from the membrane to expose a second adhesive surface. Next, the process may secure (at 640) flooring to the second adhesive surface(s) and then may end.

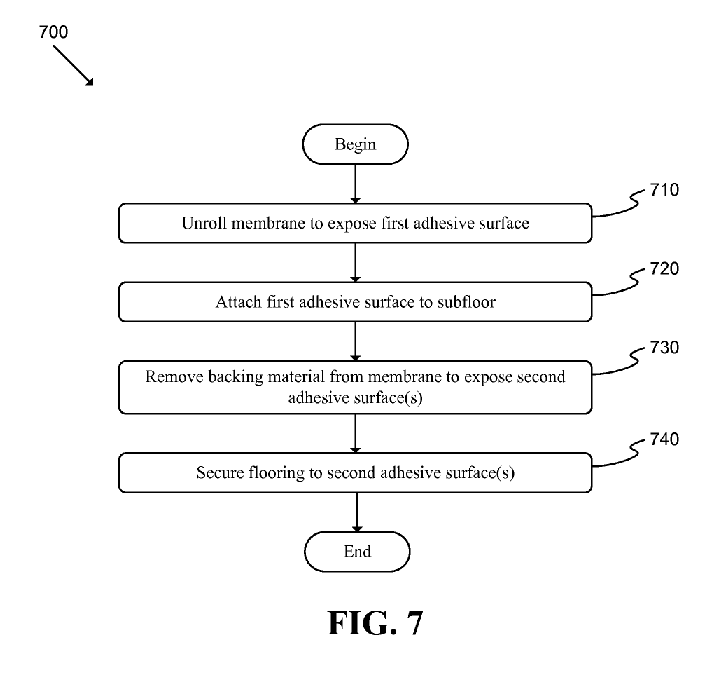

FIG. 7 illustrates a flow chart of a conceptual process 700 used by some embodiments to perform an installation using the alternative membrane configuration of FIG. 4. Process 700 may be implemented using, for example, the membrane described above in relation to FIGS. 1-5, in the configuration described in reference to FIGS. 4-5. Such a process may begin, for instance, when a roll of membrane is made available. The process may unroll (at 710) the membrane to expose a first adhesive surface. The process may then attach (at 720) the first adhesive surface to a subfloor. Such attachment may be accomplished by pressing the membrane onto the subfloor with sufficient force to adhere the first adhesive surface to the subfloor. In addition, the membrane may be cut to length or otherwise shaped to fit the subfloor such that the membrane is no longer attached to the roll.

Process 700 may then remove (at 730) backing material from the membrane to expose a second adhesive surface (or set of surfaces). The backing material may be removed from a section of the membrane corresponding to characteristics of the finish material (e.g., width of wood flooring or tile). Next, the process may secure (at 740) flooring to the exposed portion(s) of the second adhesive surface(s) and then may end.

One of ordinary skill in the art will recognize that processes 600 and 700 may be implemented in various different ways without departing from the spirit of the invention. For instance, various other operations may be included in some embodiments. As another example, although processes 600 and 700 refer to a subfloor and flooring, various other surfaces and materials may be used, as appropriate.

It should be understood, of course, that the foregoing relates to illustrative details of exemplary embodiments of the invention and that modifications may be made without departing from the spirit and scope of the invention as defined by the following claims.

We claim:

1. A finish material installation membrane comprising:
a first adhesive layer;
a structural layer coupled to the first adhesive layer;
a second adhesive layer coupled to the structural layer, and
a backing layer coupled to the second adhesive layer.

2. The finish material installation membrane of claim 1, wherein the membrane is rolled about a core.

3. The finish material installation membrane of claim 2, wherein the core is a cylinder.

4. The finish material installation membrane of claim 1, wherein the structural layer comprises closed-cell foam rubber.

5. The finish material installation membrane of claim 1, wherein the structural layer comprises neoprene.

6. The finish material installation membrane of claim 1, wherein the structural layer comprises styrene-butadiene rubber.

7. The finish material installation membrane of claim 1, wherein the second adhesive layer comprises a plurality of adhesive sections and a plurality of empty spaces among the adhesive sections.

8. A double-sided adhesive membrane adapted to secure finish material to a sub-surface, the double sided adhesive membrane comprising:
a structural layer;
a first adhesive layer coupled to a first surface of the structural layer;
a second adhesive layer coupled to a second surface of the structural layer;
a first release liner coupled to the first adhesive layer; and
a second release liner coupled to the second adhesive layer.

9. The double-sided adhesive membrane of claim 8, wherein the membrane is formed into a rectangular sheet.

10. The double-sided adhesive membrane of claim 8, wherein the structural layer comprises closed-cell foam rubber.

11. The double-sided adhesive membrane of claim 8, wherein the structural layer comprises neoprene.

12. The double-sided adhesive membrane of claim 8, wherein the structural layer comprises styrene-butadiene rubber.

13. The double-sided adhesive membrane of claim 8, wherein the first adhesive layer is adapted to allow the membrane to be secured to a subfloor using applied pressure.

14. The double-sided adhesive membrane of claim 8, wherein the second adhesive layer is adapted to allow finish flooring material to be secured to the membrane using applied pressure.

15. The double-sided adhesive membrane of claim 14, wherein the second adhesive layer is adapted to allow the finish flooring material to be repositioned for a period of time before a secure bond is formed between the finish flooring material and the second adhesive layer.

16. A method of installing finish material to a sub-surface using a double-sided adhesive membrane, the method comprising:
removing a first release liner from the adhesive membrane to expose a first adhesive layer;
securing the adhesive membrane to the sub-surface via the first adhesive layer;
removing a second release liner from the adhesive membrane to expose a second adhesive layer; and
securing finish material to the second adhesive layer.

17. The method of claim 16 further comprising:
removing the finish material from the second adhesive layer;
repositioning the finish material; and
securing the finish material to the second adhesive layer.

18. The method of claim 16, wherein the double-sided adhesive membrane is formed in rectangular sheets.

19. The method of claim 18, wherein a plurality of rectangular sheets are used to install the finish material across a section of the sub-surface.

20. The method of claim 16, wherein the sub-surface is a subfloor and the finish material is flooring.
